(19) United States
(12) Patent Application Publication
(10) Pub. No.: US 2025/0238270 A1
(43) Pub. Date: Jul. 24, 2025

(54) TECHNOLOGIES FOR MANAGING PROCESSOR POWER UTILIZATION AND PERFORMANCE

(71) Applicant: Intel Corporation, Santa Clara, CA (US)

(72) Inventors: Min ZHANG, Shanghai (CN); Yi WANG, Shanghai (CN); Gang CAO, Shanghai (CN)

(21) Appl. No.: 19/175,295

(22) Filed: Apr. 10, 2025

(30) Foreign Application Priority Data
Mar. 4, 2025 (WO) PCT/CN2025/080460

(51) Int. Cl. G06F 9/50

(52) U.S. Cl. CPC G06F 9/5027; G06F 9/5016; G06F 9/5094

(57) ABSTRACT

Examples described herein relate to a first computing platform comprising a first plurality of cores of first characteristics; a second computing platform comprising a second plurality of cores of second characteristics; and circuitry to migrate a process from execution by a first core of the first plurality of performance cores to execution by a second core of the second plurality of efficiency cores based on a configuration.

### RELATED APPLICATION

This application claims the benefit of priority to Patent Cooperation Treaty (PCT) Application No. PCT/CN2025/080460 filed Mar. 4, 2025. The entire content of that application is incorporated by reference.

### BACKGROUND

Data centers provide vast processing, storage, and networking resources to users. For example, automobiles, smart phones, desktops, laptops, tablet computers, or internet of things (IoT) devices can leverage data centers to perform data analysis, data storage, or data retrieval. Data centers configure the processing, storage, and networking operations to manage power consumption while achieving performance goals.

### BRIEF DESCRIPTION OF THE DRAWINGS

FIG. 1 depicts an example system.

FIG. 2 depicts an example system.

FIG. 3 depicts an example of memory allocation.

FIG. 4 depicts an example of accesses to memory by processes.

FIG. 5 depicts an example of measurements of power efficiency for different processor utilization values.

FIG. 6 depicts an example process.

FIG. 7 depicts an example system.

### DETAILED DESCRIPTION

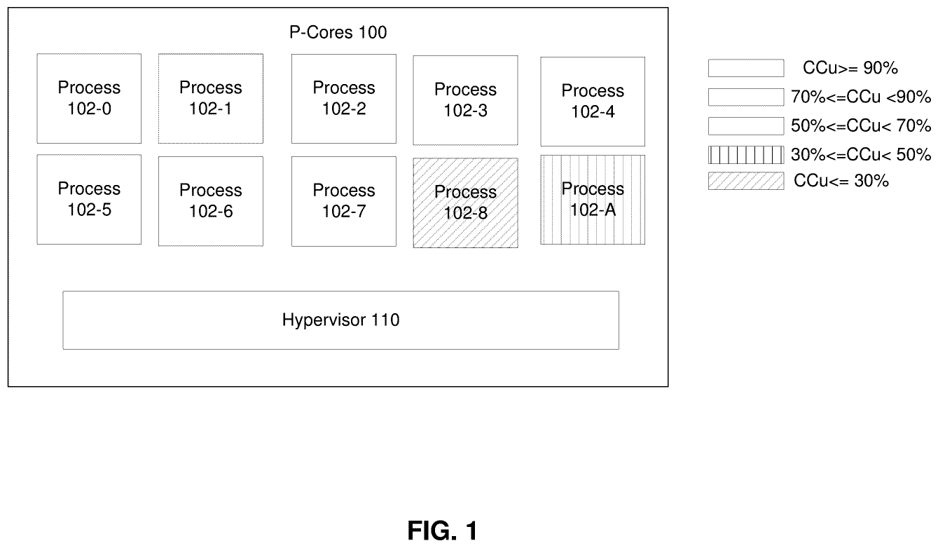

FIG. 1 depicts an example of processor utilization on a platform with cores with first operating characteristics (e.g., performance cores (P-Cores)). Hypervisor 110 can allocate processes 102-0 to 102-A, where A is an integer, to execute on P-cores 100. In some examples, P-cores 100 can prioritize completing operations (e.g., instructions) over power savings. Processes 102-0 to 102-A can include at least virtual machines (VMs), containers, threads, or other processor-executable instructions. Where processes 102-0 to 102-A are allocated to execute on P-cores 100, but the processes are idle or allow P-cores 100 to have unutilized processing capability, power may be wasted. To increase processor usage efficiency and potentially reduce power consumption, a cloud service provider (CSP) may configure hypervisor 110 to overcommit processes to execute on P-cores 100, which can decrease performance of the processes.

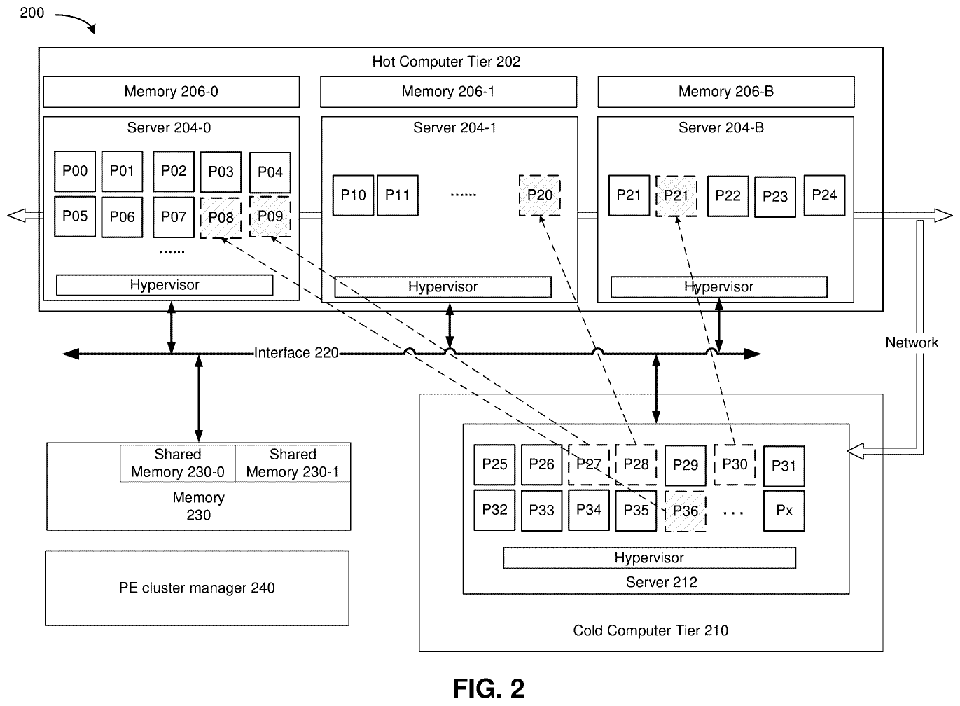

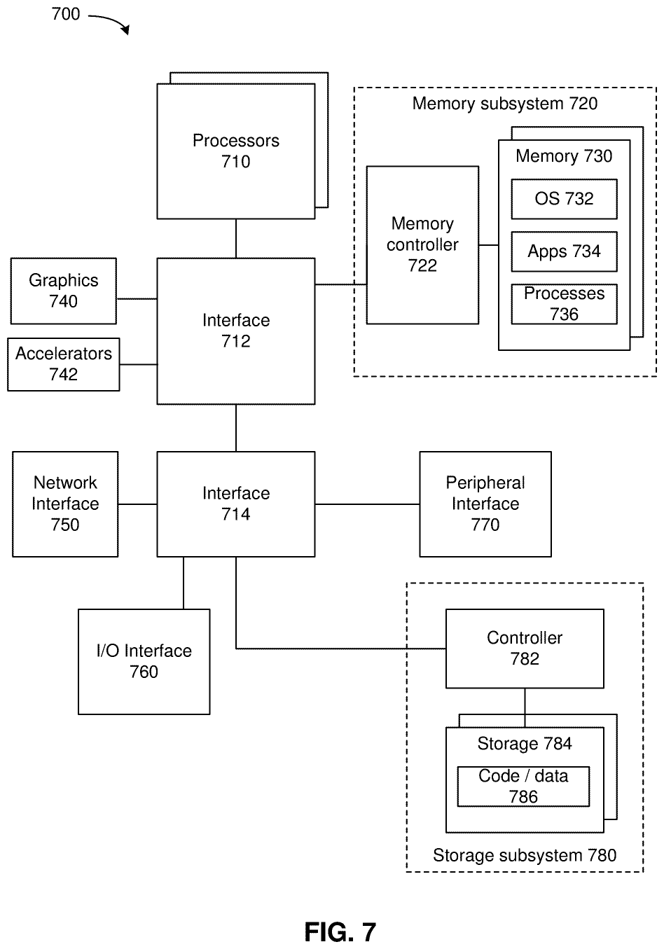

FIG. 2 depicts an example system that includes platforms with cores with first and second characteristics. For example, system 200 can include a platform that includes servers 204-0 to 204-B, where B is an integer, with one or more cores of the first operating characteristics (e.g., P-cores). Server 212 can include cores of second characteristics. Although a single server with second characteristics is depicted, multiple servers with cores with second characteristics can be used. Examples of servers 204-0 to 204-B and server 212 can include circuitry, hardware, software, and other components described at least with respect to FIG. 7. In some examples, a server can include cores with a mixture of first characteristics and second characteristics. In some examples, 204-0 to 204-B and/or server 212 can be implemented in one or more of: a circuit board that communicatively couples cores, system on chip (SoC), computing platform, a network interface device, a graphics processing unit, a memory device, a storage device, an accelerator, or others.

By comparison, a core with the first characteristics (e.g., P-core) can provide more powerful performance such as completion of instructions in fewer clock cycles than clock cycles to perform the same instructions by core with the second characteristics (e.g., E-core). However, the P-core may have higher Thermal Design Power (TDP) as compared to the E-core and consume more power than the E-core to complete the instructions. The E-core may provide more power efficient performance per Watt compared to the P-core. The E-core may occupy less physical space than the P-core. The P-core may execute multiple threads in parallel (e.g., hyper threading), whereas a E-core may perform a single thread at a time. A thread can represent a sequence of instructions. The P-core can operate at higher frequencies than an E-core.

One or more of P-cores and E-cores can include a processor core, which can include an execution core or computational engine that is capable of executing instructions. A core can access to its own cache and read only memory (ROM), or multiple cores can share a cache or ROM. Cores can be homogeneous (e.g., same processing capabilities) and/or heterogeneous devices (e.g., different processing capabilities). Frequency or power use of a core can be adjustable. A core can be sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others. P-cores and E-cores can execute instructions of the same ISA or different ISAs.

P-core servers 204-0 to 204-B can be communicatively coupled to E-core server 212 and memory 230 via interface 220. Similarly, E-core server 212 can be communicatively coupled to P-core servers 204-0 to 204-B and memory 230 via interface 220. For example, interface 220 can provide communications in a manner consistent with interconnection standards such as Advanced Micro Devices, Inc. (AMD), AMD HyperTransport, NVIDIA® NVLink, Intel® QuickPath Interconnect (QPI), Advanced Microcontroller Bus Architecture (AMBA), Coherent Hub Interface (CHI) Chip to Chip (C2C), TileLink, RISC-V processor interconnect, Intel® Ultra Path Interconnect (UPI), Intel® On-Chip System Fabric (IOSF), Omnipath, Compute Express Link (CXL) (see, for example, Compute Express Link Specification revision 2.0, version 0.7 (2019), as well as earlier versions, later versions, and variations thereof), Peripheral Component Interconnect express (PCIe) (see, for example, Peripheral Component Interconnect (PCI) Express Base Specification 1.0 (2002), as well as earlier versions, later versions, and variations thereof), or other public or proprietary standards.

Memory 230 can include one or more of: volatile memory devices, memory pool with dual inline memory modules (DIMMs), non-volatile memory devices, or other data storage devices.

PE cluster manager 240 can schedule processes (e.g., P0 to Px) for execution on one or more cores on P-core servers 204-0 to 204-B (e.g., hot computer tier 202) or schedule the processes on E-core server 212 (e.g., cold computer tier 210) to achieve performance goals but decrease power consumption, as described herein. A process can include one or more of: application, thread, a virtual machine (VM), microVM, container, microservice, or other virtualized execution environment. Various examples of processes can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in ETSI specifications or Open Source NFV MANO from ETSI's Open Source Mano (OSM) group. Processes can include virtual network function (VNF), such as a service chain or sequence of virtualized tasks executed on generic configurable hardware such as firewalls, domain name system (DNS), caching or network address translation (NAT) and can run in virtual execution environments. VNFs can be linked together as a service chain. Processes can include a cloud native network function (CNF), which can include a network function that executes inside a container. In some examples, EPC is a 3GPP-specified core architecture at least for Long Term Evolution (LTE) access. 5G network slicing can provide for multiplexing of virtualized and independent logical networks on the same physical network infrastructure. Some processes can perform video processing or media transcoding (e.g., changing the encoding of audio, image or video files).

In a PE cluster system with platforms having cores of different operating characteristics, at least to attempt to reduce utilization of cores in a platform with cores of a first type when a core of the platform is available and can achieve performance goals, PE cluster manager 140 can manage scheduling of processes on cores of the platforms to balance the performance and power efficiency (e.g., watts per task or task per watts) targets specified in an service level agreement (SLA) that applies to the CSP, customer, processes, data center, or servers. In some examples, PE cluster manager 140 can allocate one or more cores of servers 100-0 to 100-N to execute a process based on one or more of: core utilization, computing cluster utilization (e.g., utilization of a P-core server or E-core server), priority of the process, and/or power consumption parameters. Core utilization of a core of first or second operating characteristics can represent one or more of: a percentage of time a core is performing operations or processing instructions; an amount of work handled by a core within a specified time frame; for a time duration, a percentage of clock cycles utilized to perform operations over a total number of clock cycles; over a time duration, average percentage of clock cycles utilized to perform operations; over a time duration, average temperature relative to a peak operating temperature; percentage of time performing user-initiated operations such as reads, writes, and commits; percentage of the core resources of user-initiated tasks and system-initiated tasks; or others.

Various examples can balance the performance and efficiency of the computer cluster with automatically scheduling the process among servers 204-0 to 204-B and server 212 that share access to memory 230. For example, an SLA can specify a ratio of cores in P-core and E-core servers to allocate to perform processes.

For example, based on usage of E-core and/or P-core, PE cluster manager 240 can migrate one or more processes from execution on one or more cores of server 212 to execution on one or more cores of servers 204-0 to 204-B to achieve utilization levels of approximately 70% to 80% on cores of servers 204-0 to 204-B and approximately 95% on E-cores of server 212. A utilization level of a P-core or E-core can represent a percentage of time a processor is performing operations or processing instructions or an amount of work handled by a core within a specified time frame.

For example, PE cluster manager 240 can migrate processes executing on, e.g., X % or more of E-cores, to execution on one or more P-cores. For example, processes that execute on, e.g., Y % or fewer of P-core resources, can be migrated to execute on one or more E-cores. The values of X and Y can be configured by a data center administrator.

PE cluster manager 140 can be implemented as one or more of: circuitry, firmware, a user space process executed by a processor, a kernel space process executed by a processor, accelerator core, or others. PE cluster manager 140 can be implemented as a hypervisor, virtual machine manager, or other software or hardware.

In some examples, the process can be migrated from execution on a first core to execute on a second core where the first core and the second core access data from a same memory using memory interface 220.

An example of operations can be as follows. At (1), in a PE cluster with P-core platform (“hot computer tier”) and E-core platform (“cold computer tier”), a P/E core number ratio can be associated with execution of processes based on a configuration. The processes can have performance goals specified in an SLA or SLO. At (1), one or more processes can be scheduled to execute on cores of a P-core server. At (2), a determination can be made of CPU and Computability usage (CCu) of the one or more cores that execute the process. CCu can represent core utilization for specific workloads or other measurements described herein. For example, CCu of the E-core and P-core can represent a percentage of time a core is performing operations or processing instructions over a time duration; a percentage of clock cycles utilized to perform operations over a total number of clock cycles; an average percentage of clock cycles utilized to perform operations; percentage of time performing user-initiated operations such as reads, writes, and commits of the process; or others. In this example, to execute one specific workload, CCu for execution of the workload on the E-core platform can be 80% core usage, and CCu for execution of the workload on the P-core platform can be 40% core usage. However, other values of core usage can be measured.

At (3), a scheduler service (e.g. PE cluster manager 140) can monitor and manage CCu of the P-core and E-core servers. At (4), based on CCu of the one or more cores that execute the process is equal to or more than 70% utilization, then the process can remain executing on the hot computer tier. However, based on CCu of the one or more cores that execute the process is less than 70% utilization, then the process can be migrated to execute on the cold computer tier (e.g., one or more cores of the E-core server). Other values of core utilization or use to trigger migration can be used.

In some examples, to determine when to migrate a process for execution on another core (e.g., P-core or E-core), in addition, or alternative to measuring CCu of P-core and E-core servers, the scheduler service can apply an exponential-smoothing (ES) scheme, artificial intelligence (AI), machine learning (ML), or other schemes to predict CCu usage trends and schedule or migrate a process to P-core or E-core tier based on predicted CCu levels relative to one or more computing utilization (CCu) and computing capability (CCc) levels, as described herein. For example, PE cluster manager 140 can maintain or access a database of historical CCu statistics from execution of processes that includes telemetry of a platform during execution of the process. Telemetry can include one or more of: TLB hit/miss rate per process, bus read/write bandwidth per process, read latency, read latency accumulation, service slice utilization (e.g., cipher utilization level, compression utilization level, Public Key Encryption (PKE) utilization), power consumption, power state, power transitions, cache misses, memory bandwidth utilization, memory size usage, memory allocation, core clock frequency speed, core clock cycle utilization, networking bandwidth used, core idle measurement, core execution of user space processes, core waiting for an input/output operation to complete, cache allocation/utilization, network interface bandwidth (transmit or receive) utilization, CPU cycle utilization, GPU cycle utilization, database transactions/second, Collected telemetry, performance monitoring unit (PMU) counters, performance monitoring counters (PMON), performance counter monitor (see, e.g., Willhalm, “Intel® Performance Counter Monitor—A Better Way to Measure CPU Utilization” (2017)), and so forth.

In some examples, the process can be migrated from execution on the P-core platform to execution on the E-core platform or migrated from execution on the E-core platform to execution on the P-core platform over a CXL bus (e.g., interface 220) between P-core platform and E-core platform. In some examples, a P-core node can be paired to an E-core node and cores of the P-core platform and E-core platform can share access to memory 230 accessible via the CXL bus. Before and after migration of the process, a CXL memory address can be maintained so that the process can access data from a same memory address before and after migration of the process.

To migrate a process, scheduler service can notify the hypervisor, that executes on the server (e.g., P-core or E-core) that executes the process to be migrated, to migrate the process to the target server (e.g., E-core or P-core).

The system can be applied in a private cloud or public cloud provider. The private cloud or public cloud provider may provide to customers performance and resource allocation according to a service level agreement (SLA). For example, an SLA or service level objective (SLO) can specify at least one or more of: allocated memory bandwidth, allocated memory, allocated storage bandwidth, allocated storage, allocated network interface device bandwidth, allocated number of cores, processor utilization percentage, processor operating frequency, system uptime, number of generated frames per second (FPS), number of operations performed per second (OPS), or other criteria.

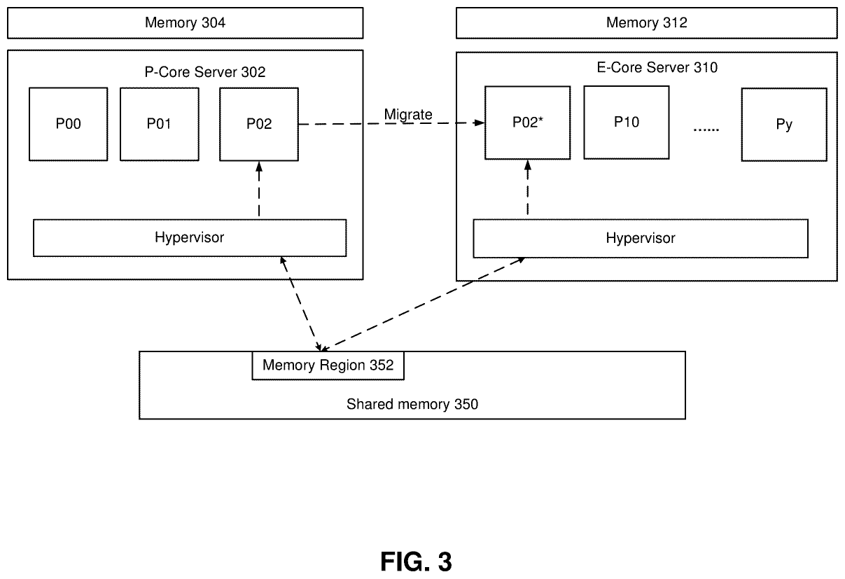

FIG. 3 depicts a shared memory 350 that is accessible as a second tier memory or far memory of process P02 that is executing on P-core server 302. Process P02, executing on P-core server 302, can access data stored in memory region 352. Local attached memory 304 can provide a memory cache for data stored in memory region 352 for processes executed P-core server 302. Based on meeting or exceeding migration criteria, the process P02 can be migrated to execute on E-core server 310. After migration of process P02 to execute on E-core server 310, process P02 (shown as P02*) can access data stored in memory region 352. After migration of process P02 from execution on P-core server 302 to execute on E-core server 310, local attached memory 312 can provide a memory cache for data stored in memory region 352 for access by P02*.

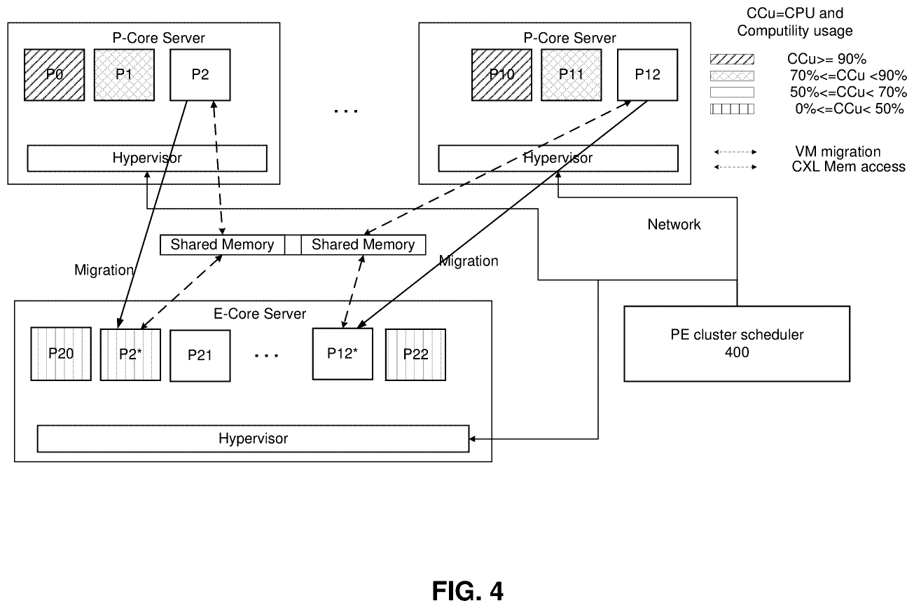

FIG. 4 depicts an example of migrations. A datacenter administrator can define a P/E core number ratio in the PE cluster (e.g., number of allocated P-cores and allocated E-cores) based on performance and power consumption targets. For example, a datacenter administrator can determine a percentage for processes to execute on a cold tier (e.g., E-core server) based on CCU usage statistics from a history log from prior executions of the process in cluster. For example, if in one computing cluster, about 10% of processes executing on E-cores can maintain a CCu state of approximately less than or equal to 70%, then the P/E core-ratio can be 10:1. For example, for a P/E core-ratio of 10:1, 1440 P-cores can be paired with 144 E-cores so that scheduling and migration of processes can be among the 1440 P-cores and 144 E-cores. For example, if a process executed in one or more E-cores has begun to use more than a threshold level of CCu (e.g., >70%), then the process can be rescheduled or migrated to execute on one or more P-cores of the 1440 P-cores.

In some examples, a datacenter administrator can define the CCu threshold level (e.g., 70%) for tiering swap and configure PE cluster scheduler 400 to perform process migrations from P-core to E-core or from E-core to P-core based on CCu levels. The threshold can be defined according to the P-core/E-core computing capability and power profiling, business needs and deployment scenarios. The administrator can have information about CPU usage and computing capability for P-cores and E-cores, and a computing capability map between P-core and E-core. For example, if a process running on P-cores consume 70% CCu of the P-cores, scheduler 400 can check if E-cores can execute the process for lower power consumption than on P-cores.

In some examples, a process can be migrated from execution on a cold computer tier to execution on a hot computer tier or execution on a hot computer tier to execution on a cold computer tier based on: usage of the computing capability for the process when executing on the assigned E-core(s) or P-core(s) and computing capability for the E-core or P-core platform. For example, scheduler 400 can migrate a process from a hot computer tier (e.g., P-core(s)) to a cold compute tier (e.g., E-core(s)) or maintain execution of the process on the cold compute tier if:
process CCu≤E-Cores CCc AND
process CCu≤70% of P-Core CCc AND
Power consumption on an E-core with CCu between [0 to 100%]≤Power consumption on P-Core with CCu between [0 to 70%]
   where:
process CCu can represent the usage of cores (e.g., E-cores or P-cores) by the process;
E-core CCc can represent a total processing or computing capability for E-cores; and
P-core CCc can represent a total available processing or computing capability for P-cores, whereby the P-core CCc can have a higher CCc than E-core CCc. Available processing or computing capability can indicate a total available non-utilized computing capacity and can represent a sum of unutilized computing capacity of cores. For example, E-core CCc can represent a total or average percentage of unutilized computing capacity of E-cores. For example, P-core CCc can represent a total or average percentage of unutilized computing capacity of P-cores.

In other words, scheduler 400 can migrate a process for execution on a cold compute tier (e.g., E-cores or energy efficient compute) or maintain execution of the process on the cold compute tier if: (1) utilization of E-cores by the process is less than or equal to available E-core computing capability, (2) utilization of P-cores by the process is less than or equal to 70% of available P-core computing capability, and/or (3) power consumption by the process on E-cores with utilization in the range of [0 to 100%] is less than or equal to the power consumption on the P-cores with P-core computing resource usage in the range of [0 to 70%]. Other percentages of computing capability and utilization can be used.

In some examples, scheduler 400 can migrate a process for execution on a cold compute tier (e.g., E-cores or energy efficient compute) based on power consumption by the cold compute tier being less than or equal to power consumption by the current hot computing tier.

In some examples, scheduler 400 can migrate a process for execution on a cold compute tier (e.g., E-cores or energy efficient compute) based on power consumption by the cold compute tier expected to be less than or equal to power consumption by the current hot computing tier and performance (e.g., time to completion of the process) expected to be equal to or greater than performance by the current hot computing tier.

In some examples, scheduler 400 can migrate a process for execution on a cold compute tier (e.g., E-cores or energy efficient compute) based on power consumption by the cold compute tier expected to be less than or equal to power consumption by the current hot computing tier and performance (e.g., time to completion of the process) expected to be greater than performance by the current hot computing tier or degrade no more than A %, where A is configured by the data center administrator.

For example, scheduler 400 can migrate the process from a cold computer tier (e.g., E-core(s)) to a hot compute tier (e.g., P-core(s)) or maintain execution of the process on the hot compute tier if:
E-Cores CCc≤instance CCu≤100% of P-Core CCc OR
Power consumption on E-core≥Power Consumption on P-Core in the range of [0 to 70%].

In other words, scheduler 400 can migrate a process for execution on a hot compute tier (e.g., P-cores or performance compute) or maintain execution of the process on the hot compute tier if: (1) available E-core computing capability is less than or equal to utilization of E-cores by the process and utilization of E-cores by the process is less than or equal to full available P-core computing capability, or (2) power consumption by the process on the E-core is greater than or equal to power consumption by the process on [0 to 70%] of available P-core computing capability. All values are exemplary and other values can be used.

In some examples, scheduler 400 can migrate a process for execution on a hot compute tier (e.g., P-cores or performance compute) based on power consumption by the hot compute tier being less than or equal to power consumption by the current cold computing tier.

In some examples, scheduler 400 can migrate a process for execution on a hot computing tier based on power consumption by the hot compute tier expected to be less than or equal to power consumption by the current cold computing tier and performance (e.g., time to completion of the process) expected to be equal to or greater than performance by the current cold computing tier.

In some examples, scheduler 400 can migrate a process for execution on a hot computing tier based on power consumption by the hot compute tier expected to be less than or equal to power consumption by the current cold computing tier and performance (e.g., time to completion of the process) expected to be equal or greater than performance by the current cold computing tier or degrade no more than A %, where A is configured by the data center administrator.

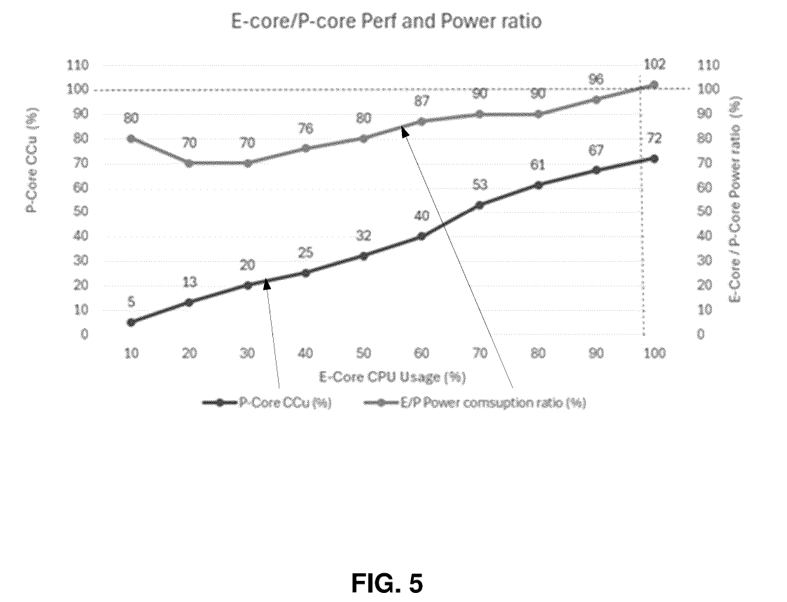

FIG. 5 depicts an example of measurements of power efficiency for different processor utilization values. In this example, a process executes on E-cores and P-cores with similar key performance indicators (KPIs). KPIs can include at least processor usage percentage, average processing time, number of context switches, uptime, or other metrics. The relationship P-core CCu shows a E-core CPU and P-Core CPU computing usage relationship in terms of percentage. For example, when the process uses E-cores at CCu of 10%, the process alternatively could consume 5% CCu when executing on a P-Core and the E-core power consumption is 80% of the P-core power consumption. For example, when the process uses 90% CCu of a E-core, the process would alternatively consume 67% CCu of a P-Core, and E-core power consumption is 96% of the P-core power consumption. For example, when the process uses 100% CCu of an E-core, the process would alternatively consume 72% CCu of a P-core, and an E-core/P-core power consumption ratio can be approximately 100%. Accordingly, if a CCu of a process is less than or equal to 70% when executing on a P-core, then migrating this process to an E-core can improve power efficiency and retain performance.

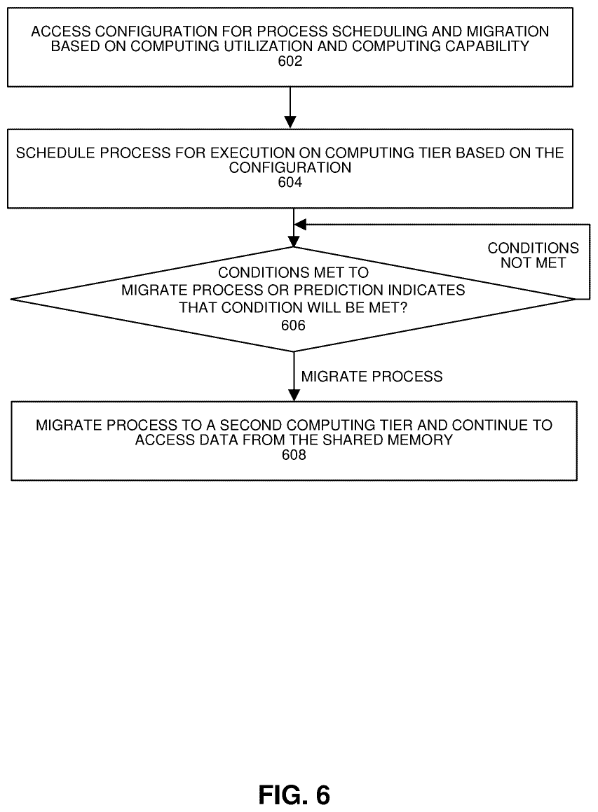

FIG. 6 depicts an example process. The process can be performed by a processor or scheduler. At 602, a scheduler can be configured to determine whether to schedule a process that is executing on a computing tier (e.g., hot or cold) for execution on the same computing tier or a different computing tier. For example, the configuration can indicate computing utilization and computing capability values that trigger migration of the process to additional or fewer processors of its current computing tier or to one or more processors of a different computing tier.

At 604, the scheduler can cause execution of the process on a computing tier based on the configuration. For example, the configuration can specify to prioritize execution on an energy efficient or cold computing tier or prioritize execution on a performance core or hot computing tier. In some examples, the configuration may prioritize reducing energy consumption even if the performance diminishes. At 606, based on a current computing capability of a computing tier that executes the process and computing utilization of the process being within value ranges specified in the configuration that cause migration of the process, at 608, the scheduler can cause the process to execute on a computing tier specified in the configuration. For example, the configuration can specify that the process, that executes on a hot computing tier, can instead execute on a cold computing tier. For example, the configuration can specify that the process, that executes on a cold computing tier, can instead execute on a hot computing tier. For example, the configuration can specify that the process, that executes on a cold computing tier, can execute on fewer or more cores of the cold computing tier. For example, the configuration can specify that the process, that executes on a hot computing tier, can execute on fewer or more cores of the hot computing tier.

FIG. 7 depicts a system. In some examples, a process can be migrated to more power efficient processors to reduce power consumption and achieve performance goals, as described herein. System 700 includes processor 710, which provides processing, operation management, and execution of instructions for system 700. Processor 710 can include any type of microprocessor, central processing unit (CPU), graphics processing unit (GPU), XPU, processing core, or other processing hardware to provide processing for system 700, or a combination of processors. An XPU can include one or more of: a CPU, a graphics processing unit (GPU), general purpose GPU (GPGPU), and/or other processing units (e.g., accelerators or programmable or fixed function FPGAs). Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processor 710 can include multiple processors and multiple processors can be embodied as processor sockets. Processor 710 can include E-cores or P-cores, described herein.

In one example, system 700 includes interface 712 coupled to processor 710, which can represent a higher speed interface or a high throughput interface for system components, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a programmable or fixed function offload engine that can be accessed or used by a processor 710. For example, an accelerator among accelerators 742 can provide data compression (DC) capability, cryptography services such as public key encryption (PKE), cipher, hash/authentication capabilities, decryption, or other capabilities or services. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 742 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

Applications 734 and/or processes 736 can refer instead or additionally to a virtual machine (VM), container (e.g., Docker container), microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 732 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers, workstations, or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory. Network interface 750 can receive data from a remote device, which can include storing received data into memory. In some examples, packet processing device or network interface device 750 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described herein.

In one example, system 700 includes one or more input/output (I/O) interface(s) 760. I/O interface 760 can include one or more interface components through which a user interacts with system 700. Peripheral interface 770 can include any hardware interface not specifically mentioned above. Peripherals refer generally to devices that connect dependently to system 700.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 700 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications. Die-to-die communications can utilize Embedded Multi-Die Interconnect Bridge (EMIB) or an interposer. Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: an SoC, one or more tiles, or other circuitry.

In an example, system 700 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.’”

Illustrative examples of the devices, systems, and methods disclosed herein are provided below. An embodiment of the devices, systems, and methods may include any one or more, and any combination of, the examples described below.

Example 1 includes one or more examples and includes an apparatus: a first computing platform comprising a first plurality of cores of first characteristics; a second computing platform comprising a second plurality of cores of second characteristics; and circuitry to migrate a process from execution by a first core of the first plurality of cores to execution by a second core of the second plurality of cores based on a configuration, wherein: the configuration is to specify levels of utilization of the first plurality of cores of first characteristics and/or capabilities of the first plurality of cores and the second plurality of cores to cause change from execution on the first core to execution on the second core and the first core is to complete operations at higher power utilization and in less time compared to performance of the operations by the second core of the second plurality of cores.

Example 2 includes one or more examples, wherein: based on the configuration, the circuitry is to migrate the process from execution by the second core of the second plurality of cores to execution by a third core of the first plurality of cores.

Example 3 includes one or more examples, and includes a memory interface to communicatively couple the first plurality of cores and the second plurality of cores, wherein the memory interface is to store data accessible to the process executed by the first core and the migrated process executed by the second core.

Example 4 includes one or more examples, wherein: the circuitry is to change from execution on the first core to execution on the second core based on a prediction that utilization of the first core and capabilities of the first plurality of cores and second plurality of cores are to be met based on prior performances of the process.

Example 5 includes one or more examples, wherein: the configuration is to specify first core utilization and capabilities of the first plurality of cores and second plurality of cores to cause change from execution on the first core to execution on multiple cores of the first plurality of cores.

Example 6 includes one or more examples, wherein: the configuration is to specify a number of cores of the first plurality of cores and a number of cores of the second plurality of cores to allocate to perform the process.

Example 7 includes one or more examples, wherein: the utilization of the first plurality of cores of first characteristics comprises a measure of workload performed by the first plurality of cores of first characteristics; the capabilities of the first plurality of cores of first characteristics comprise a measure of workload capable of being performed by the first plurality of cores of first characteristics; and the capabilities of the second plurality of cores of second characteristics comprise a measure of workload capable of being performed by the second plurality of cores of second characteristics.

Example 8 includes one or more examples, and includes at least one non-transitory computer-readable medium comprising instructions stored thereon, that if executed by one or more processors of a host interface in a network interface device, cause the one or more processors to: assign a process to execute on at least one core of a first plurality of cores and/or a second plurality of cores and based on a level of core utilization and levels of capabilities of the first plurality of cores and the second plurality of cores, change the process from execution on the at least one core to execution on a second at least one core of the first plurality of cores and/or the second plurality of cores, wherein a core of the first plurality of cores is to complete operations at higher power utilization and in less time compared to performance of the operations by a core of the second plurality of cores.

Example 9 includes one or more examples, wherein: the level of core utilization comprises a measure of workload performed by the core; the levels of capabilities of the first plurality of cores comprise a measure of workload capable of being performed by the first plurality of cores; and the levels of capabilities of the second plurality of cores comprise a measure of workload capable of being performed by the second plurality of cores.

Example 10 includes one or more examples, wherein: the change the process from execution on the at least one core to execution on a second at least one core of the first plurality of cores and/or the second plurality of cores is to reduce power consumption and retain performance.

Example 11 includes one or more examples, wherein: change the process from execution on the at least one core to execution on a second at least one core of the first plurality of cores and/or the second plurality of cores is based on machine learning (ML) inference from prior performances of the process.

Example 12 includes one or more examples, wherein the second at least one core of the first plurality of cores and/or the second plurality of cores comprises multiple cores of the first plurality of cores and/or the second plurality of cores.

Example 13 includes one or more examples, wherein the change from execution on the at least one core to execution on a second at least one core of the first plurality of cores and/or the second plurality of cores utilize a memory interface to migrate the process to the execution on the second at least one core of the first plurality of cores and/or the second plurality of cores.

Example 14 includes one or more examples, and includes a method that includes: assigning a process to execute on at least one core of a first plurality of cores and/or a second plurality of cores and based on a level of core utilization and levels of capabilities of the first plurality of cores and the second plurality of cores, changing the process from execution on the at least one core to execution on a second at least one core of the first plurality of cores and/or the second plurality of cores, wherein a core of the first plurality of cores is to complete operations at higher power utilization and in less time compared to performance of the operations by a core of the second plurality of cores.

Example 15 includes one or more examples, wherein the level of core utilization comprises a measure of workload performed by the core; the levels of capabilities of the first plurality of cores comprise a measure of workload capable of being performed by the first plurality of cores; and the levels of capabilities of the second plurality of cores comprise a measure of workload capable of being performed by the second plurality of cores.

Example 16 includes one or more examples, wherein the changing the process from execution on the at least one core to execution on a second at least one core of the first plurality of cores and/or the second plurality of cores is to reduce power consumption and retain performance.

Example 17 includes one or more examples, wherein the changing the process from execution on the at least one core to execution on a second at least one core of the first plurality of cores and/or the second plurality of cores is based on machine learning (ML) inference from prior performances of the process.

Example 18 includes one or more examples, wherein the second at least one core of the first plurality of cores and/or the second plurality of cores comprises multiple cores of the first plurality of cores and/or the second plurality of cores.

Example 19 includes one or more examples, wherein the changing from execution on the at least one core to execution on a second at least one core of the first plurality of cores and/or the second plurality of cores utilizes a memory interface to migrate the process to the execution on the second at least one core of the first plurality of cores and/or the second plurality of cores.

Example 20 includes one or more examples, wherein the first plurality of cores and/or the second plurality of cores are positioned in one or more of: a data center, a server, a memory pool, a network interface device, or an accelerator.

1. An apparatus comprising:
a first computing platform comprising a first plurality of cores of first characteristics;
a second computing platform comprising a second plurality of cores of second characteristics; and
circuitry to migrate a process from execution by a first core of the first plurality of cores to execution by a second core of the second plurality of cores based on a configuration, wherein:
the configuration is to specify levels of utilization of the first plurality of cores of first characteristics and/or capabilities of the first plurality of cores and the second plurality of cores to cause change from execution on the first core to execution on the second core and
the first core is to complete operations at higher power utilization and in less time compared to performance of the operations by the second core of the second plurality of cores.

2. The apparatus of claim 1, wherein:
based on the configuration, the circuitry is to migrate the process from execution by the second core of the second plurality of cores to execution by a third core of the first plurality of cores.

3. The apparatus of claim 1, comprising:
a memory interface to communicatively couple the first plurality of cores and the second plurality of cores, wherein the memory interface is to store data accessible to the process executed by the first core and the migrated process executed by the second core.

4. The apparatus of claim 1, wherein the circuitry is to change from execution on the first core to execution on the second core based on a prediction that utilization of the first core and capabilities of the first plurality of cores and second plurality of cores are to be met based on prior performances of the process.

5. The apparatus of claim 1, wherein the configuration is to specify first core utilization and capabilities of the first plurality of cores and second plurality of cores to cause change from execution on the first core to execution on multiple cores of the first plurality of cores.

6. The apparatus of claim 1, wherein the configuration is to specify a number of cores of the first plurality of cores and a number of cores of the second plurality of cores to allocate to perform the process.

7. The apparatus of claim 1, wherein:
the utilization of the first plurality of cores of first characteristics comprises a measure of workload performed by the first plurality of cores of first characteristics;
the capabilities of the first plurality of cores of first characteristics comprise a measure of workload capable of being performed by the first plurality of cores of first characteristics; and
the capabilities of the second plurality of cores of second characteristics comprise a measure of workload capable of being performed by the second plurality of cores of second characteristics.

8. At least one non-transitory computer-readable medium comprising instructions stored thereon, that if executed by one or more processors of a host interface in a network interface device, cause the one or more processors to:
assign a process to execute on at least one core of a first plurality of cores and/or a second plurality of cores and
based on a level of core utilization and levels of capabilities of the first plurality of cores and the second plurality of cores, change the process from execution on the at least one core to execution on a second at least one core of the first plurality of cores and/or the second plurality of cores, wherein a core of the first plurality of cores is to complete operations at higher power utilization and in less time compared to performance of the operations by a core of the second plurality of cores.

9. The computer-readable medium of claim 8, wherein:
the level of core utilization comprises a measure of workload performed by the core;
the levels of capabilities of the first plurality of cores comprise a measure of workload capable of being performed by the first plurality of cores; and
the levels of capabilities of the second plurality of cores comprise a measure of workload capable of being performed by the second plurality of cores.

10. The computer-readable medium of claim 8, wherein the change the process from execution on the at least one core to execution on a second at least one core of the first plurality of cores and/or the second plurality of cores is to reduce power consumption and retain performance.

11. The computer-readable medium of claim 8, wherein change the process from execution on the at least one core to execution on a second at least one core of the first plurality of cores and/or the second plurality of cores is based on machine learning (ML) inference from prior performances of the process.

12. The computer-readable medium of claim 8, wherein the second at least one core of the first plurality of cores and/or the second plurality of cores comprises multiple cores of the first plurality of cores and/or the second plurality of cores.

13. The computer-readable medium of claim 8, wherein the change from execution on the at least one core to execution on a second at least one core of the first plurality of cores and/or the second plurality of cores utilize a memory interface to migrate the process to the execution on the second at least one core of the first plurality of cores and/or the second plurality of cores.

14. A method comprising:
assigning a process to execute on at least one core of a first plurality of cores and/or a second plurality of cores and
based on a level of core utilization and levels of capabilities of the first plurality of cores and the second plurality of cores, changing the process from execution on the at least one core to execution on a second at least one core of the first plurality of cores and/or the second plurality of cores, wherein a core of the first plurality of cores is to complete operations at higher power utilization and in less time compared to performance of the operations by a core of the second plurality of cores.

15. The method of claim 14, wherein:
the level of core utilization comprises a measure of workload performed by the core;
the levels of capabilities of the first plurality of cores comprise a measure of workload capable of being performed by the first plurality of cores; and
the levels of capabilities of the second plurality of cores comprise a measure of workload capable of being performed by the second plurality of cores.

16. The method of claim 14, wherein the changing the process from execution on the at least one core to execution on a second at least one core of the first plurality of cores and/or the second plurality of cores is to reduce power consumption and retain performance.

17. The method of claim 14, wherein the changing the process from execution on the at least one core to execution on a second at least one core of the first plurality of cores and/or the second plurality of cores is based on machine learning (ML) inference from prior performances of the process.

18. The method of claim 14, wherein the second at least one core of the first plurality of cores and/or the second plurality of cores comprises multiple cores of the first plurality of cores and/or the second plurality of cores.

19. The method of claim 14, wherein the changing from execution on the at least one core to execution on a second at least one core of the first plurality of cores and/or the second plurality of cores utilizes a memory interface to migrate the process to the execution on the second at least one core of the first plurality of cores and/or the second plurality of cores.

20. The method of claim 14, wherein the first plurality of cores and/or the second plurality of cores are positioned in one or more of: a data center, a server, a memory pool, a network interface device, or an accelerator.
